(19) United States
(12) Patent Application Publication
(10) Pub. No.: US 2013/0168189 A1
(43) Pub. Date: Jul. 4, 2013

(54) METHOD TO TRANSPORT PERSONS OVER AN ELEVATION WITH SLOPE, AND CORRESPONDING MACHINE

(71) Applicant: Antonio Ribas, Lloret de Mar (ES)

(72) Inventor: Antonio Ribas, Lloret de Mar (ES)

(21) Appl. No.: 13/590,546

(22) Filed: Aug. 21, 2012

(30) Foreign Application Priority Data
Dec. 30, 2011 (ES) 201132154

(51) Int. Cl. B66B 9/08

(52) U.S. Cl. 187/200

(57) ABSTRACT

Method to transport persons overcoming an elevation with slope, and corresponding machine. The machine is a mechanical device equipped with at least three contiguous mobile steps movable individually only in the vertical direction. The method consists in performing a detection of a footstep or the transit of a person on the mobile steps and, as a function of such detection, produce a displacement of the mobile steps individually and only in the vertical direction, controlling such displacement in a manner that at least two of such mobile steps become level in the same horizontal plane in the region of transit of the person as this person advances stepping successively the mobile steps.

### FIELD OF THE INVENTION

The invention is in the field of mechanical devices to transport persons going up or down elevations.

More specifically, the invention refers to a method to transport persons overcoming an elevation with a slope associated with it, of the type that uses a mechanical device equipped with a plurality of mobile steps that cover that slope.

The invention also refers to a mechanism to put this method into practice.

### STATUS OF THE TECHNIQUE

There are several types of mechanical devices to transport persons over an elevation with a slope.

The first type is constituted by mechanical escalators, equipped with a plurality of retractable steps that translate together in the direction of the slope, forming a staircase in motion. Users can remain immobile on one of the steps and be transported passively at the same speed than the steps, or can move along these steps to accelerate their own motion. These mechanical escalators enable secure transportation for a considerable flow of people and for this reason they are usually installed in public places such as commercial malls, hospitals, train stations, airports, etc. The installation of a mechanical escalator of this type requires an elevated investment in equipment and an important civil construction, and for this reason they are not usually installed in private installations or in installations of low intensity use. On the other hand, mechanical escalators present the inconvenient that when they stop working, for example in the case of breakdown, although they are still passable, they are more difficult to climb or descend than a conventional fixed staircase, since in general the height of its steps is larger. It is for this reason that in general they are built next to a conventional staircase.

Mobile ramps are quite similar to mechanical escalators with the difference that, instead of steps, they have retractable plates that are positioned forming jointly an inclined plane that translates along the direction of the slope. Similar to the case of mechanical escalators, users can remain stationary, letting themselves to be translated at the speed of the inclined plane, or they may walk over such inclined plane to accelerate their movement. Like mechanical escalators, mobile ramps are suitable to transport a considerable flow of people; they get preferably installed in public places, and require an elevated investment in equipment and an important civil construction. Compared to mechanical escalators, mobile ramps are easier to transit when they are not working. However, they are not suitable to overcome large elevations.

A second type of device, which is more appropriate for private or less intensive use, is constituted by mechanical chair lifts that are installed at the side of an existing staircase and that translate along a fixed guide or rail affixed to one of the walls of the stairway, so that the user sits in the chair and gets transported by it. This type of device is often installed in houses or private buildings to enable the movement of elderly persons or persons with mobility problems, avoiding the traumatic effects of going up and down the stairs on foot. This device has the advantage that it does not require such a considerable investment, it is not such an important civil construction such as the mechanical escalators or mobile ramps, and that it can be installed on an existing staircase as a complement and without preventing its conventional use. However, this type of device has the inconvenient that the person that uses it must sit on the chair and get up from it at the end of the trajectory, which can be difficult for persons that despite being able to walk, have a limited freedom of movement or simply have some impediment to sitting.

### SUMMARY OF THE INVENTION

The purpose of the invention is to provide a procedure to transport persons of the type indicated at the beginning, which enables one person to overcome an elevation in a sloping terrain, such as that corresponding to a flight of stairs, without the need to sit on a chair and without the inconveniences previously cited for the mechanical escalators and mobile ramps.

Another objective of the invention consists in enabling a person to overcome an elevation by doing easy, natural and less traumatic movements than these related to going upstairs or downstairs by foot.

This goal is achieved by a method to transport persons overcoming an elevation with slope, which uses a mechanical device equipped with a plurality of contiguous mobile steps covering such slope. This machine is characterized by having at least three steps and this method encompasses the actions of:
Performing the detection of a footstep or of the passage of a person over such mobile steps;
As a consequence of such detection, carry out a displacement of such mobile steps individually and only in the vertical direction, controlling the individual displacement of the mobile steps such that at least two of such mobile steps arrange themselves level in the same horizontal plane in the stepping range of the person as the person advances stepping successively across the mobile steps.

The procedure described in the invention resembles the procedure of a mechanical escalator, but with the essential difference that the steps do not form a staircase that translates in the direction of the slope, but rather such steps move individually and successively and only in the vertical direction, and they position automatically in such a way that when a person walks over them, the person always does so over a horizontal platform, formed by at least two of such mobile steps, without any change in height. The speed of translation of the person has two components: one horizontal due only to the movement of the person that walks over the horizontal platform formed by the level mobile steps, and a vertical component due only to the vertical movement of such mobile steps.

Thus, the method described in the invention enables a person to overcome a slope while executing a movement that corresponds to walking over a flat surface. This movement, as well as the successive displacement of the steps as the person moves forward, is described in more detail later, in the detailed description of one of the ways to implement the invention.

The method according to the invention can function by leveling only two of the successive mobile steps as the person advances over the ensemble of the mobile steps. However, in a preferred form of implementation, which offers the easiest usage for persons, is formed by leveling three mobile steps. For this, two mobile steps are moved to become level with a contiguous third one in the direction of the person's movement. More specifically, in this preferred form of implementation the method encompasses the actions of:
Maintaining two of the mobile contiguous steps level in a horizontal plane;
When a person's footstep, or a person's passage over such two mobile contiguous steps is detected, perform a vertical displacement of these two mobile contiguous steps until they become level, in another horizontal plane, with a third of such mobile steps that is contiguous and posterior to these two first ones in the direction of movement of the person, thus forming a temporary horizontal platform formed by these three mobile contiguous steps that are now level;
Repeat the two previous actions consecutively for the mobile steps (1) that follow in the direction of movement of this person.

In another form of implementation that offers an extra level of safety in the downward direction, the method encompasses the actions of:
Detecting in the upper level of the slope a footstep or the passage of a person that will go across the machine in the direction of descent;
Maintaining level in a horizontal plane three mobile contiguous steps;
When a person's footstep or passage along the first two of such three mobile contiguous level steps is detected, execute a vertical displacement of such three mobile contiguous level steps until they become level, in another horizontal plane, with a fourth of such mobile steps that is contiguous and posterior to the first three in the direction of movement of this person, thus forming a temporary horizontal platform constituted by these four mobile contiguous level steps;
Repeat the previous actions successively for the mobile steps (1) that follow in the direction of movement of this person.

Preferably, the vertical movement of the mobile steps is performed between one lowered position and one or several elevated positions, being the trajectory of displacement between two successive such positions equal or lower than 12 inches (30.48 cm), preferably ranging between 4 inches and 8 inches (between 10.16 cm and 20.32 cm). Due to this particular configuration, the movements that a person makes when walking over the steps are very similar to those that this person would make when walking with short steps over a firm ground; thus there is practically no learning process needed.

The invention also includes a machine specially configured to carry out the method, specifically a machine to transport persons overcoming an elevation with slope, that includes a plurality of mobile steps laid out covering a slope and a mechanism of action that acts over such as mobile steps to make a displacement of these, characterized because there are at least three of such mobile steps and they are individually movable only in the vertical direction, and because such transporting machine includes a system of detection to detect the footstep or the transit of a person over such mobile steps and a control system to individually regulate the vertical displacement and the position of such mobile steps as a function of the footsteps or transit detected by such detection system over such mobile steps; this control system being configured to, as a function of the detection of footsteps or transit sensed by such detection system, through such actuating mechanism, to perform a displacement of such mobile steps individually and only in the vertical direction, controlling such individual displacement of the mobile steps in a manner that at least two of such mobile steps are placed level on the same horizontal plane in the area of stepping of the person as the person advances stepping successively on the mobile steps.

In a preferred form of implementation, the control system is configured to:
Maintain level in a horizontal plane two of such contiguous mobile steps;
When the footstep or passage of a person is detected successively over two of such contiguous mobile steps, realize a vertical displacement of two of such contiguous mobile steps until they are level, in another horizontal plane, with a third of such mobile steps that is both contiguous and posterior to the two first ones in the direction of movement of this person, thus forming a temporary horizontal platform constituted for the three contiguous, level mobile steps;
Repeat the previous actions successively for the following mobile steps in the direction of movement of such person.

In another form of implementation, the machine has a detection system to detect the footstep or transit of a person in the upper level of the slope; the control system is configured to:
Detect in the upper level of the slope a footstep or the passage of a person that is going to go across the machine in the downward direction;
Maintain level in a horizontal plane three contiguous mobile steps;
When the footstep or the passage of a person is detected successively in the first two of the three mobile contiguous level steps, make a vertical displacement of such three mobile contiguous level steps until they are level, in another (lower) horizontal plane, with a fourth of such mobile steps that is contiguous and posterior to the first three in the direction of movement of this person, thus forming a temporary horizontal platform constituted by such four mobile contiguous level steps;
Repeat the previous actions successively for the subsequent mobile steps in the direction of movement of this person.

Preferably, the mobile steps are moved vertically between one lowered position and one or several elevated positions, with the range of displacement between each two successive positions equal or lower than 12 inches (30.48 cm), and preferably between 4 and 8 inches (between 10.16 cm and 20.32 cm).

The detection system can be implemented in several ways, for example with photoelectric cells that detect the footstep of a person, or through an image recognition system able to analyze the movements of a person and detect his footsteps or transit over the steps. However, in a preferred form of execution the detection system has a footstep detector placed in each of the mobile steps. Preferably, such footstep detector is a weight sensor placed in the upper face of each of the mobile steps. This configuration offers heightened safety in the mechanism, since it enables to discriminate depending on the value of the detected weight and avoids that the mechanism works in inappropriate situations, for example when it is a child that walks over the steps.

Preferably, each of the mobile steps has a flat upper surface under which, in the lowered position of the mobile step, there is a reserved space for the installation of the engines to activate the vertical movement of such mobile step. This solution has the advantage that it enables to easily install the machine over an existing staircase, as it will be seen later on in the detailed description of one of the forms or implementation of the invention.

Other characteristics of the details that appear in the detailed description of one of the forms of implementation and in the figures also form part of the invention. These detailed descriptions are provided without limiting character with respect to the broad reach of the claims.

### BRIEF DESCRIPTION OF THE SCHEMATICS

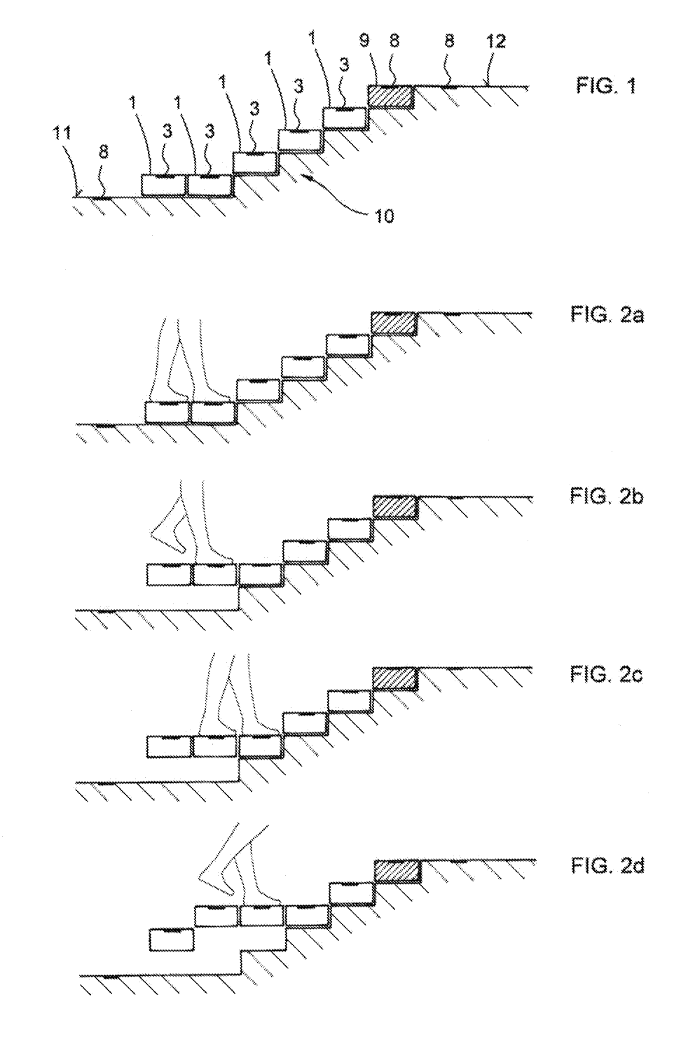

FIG. 1 is a schematic lateral view of a first form of implementation of the person-transporting machine, with all the mobile steps in their lowered position.

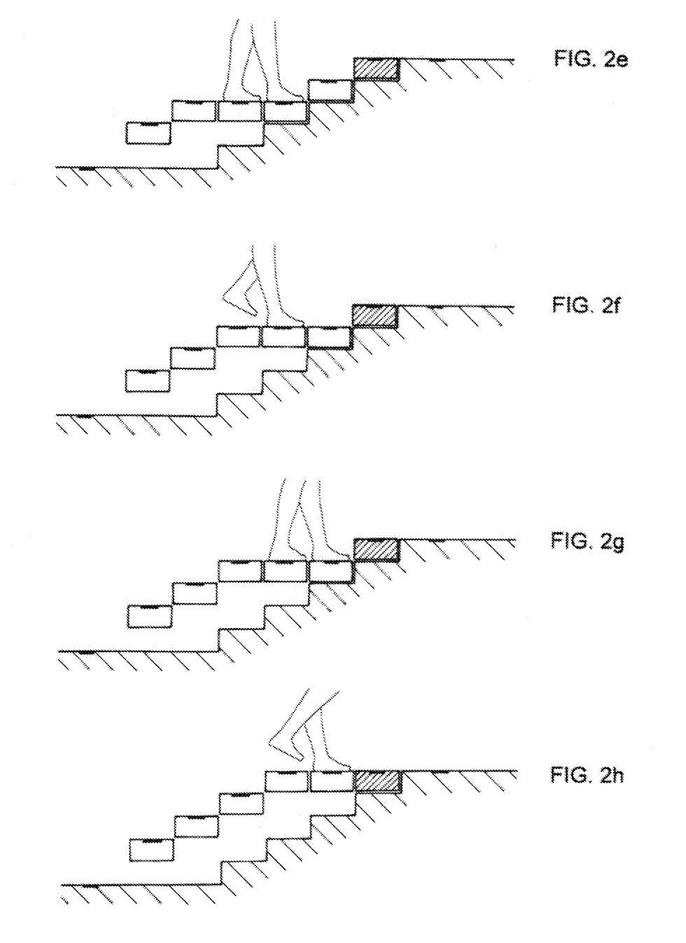

FIGS. 2a-h are schematic lateral views of the machine in FIG. 1 that illustrate the successive phases of the procedure in the upward direction.

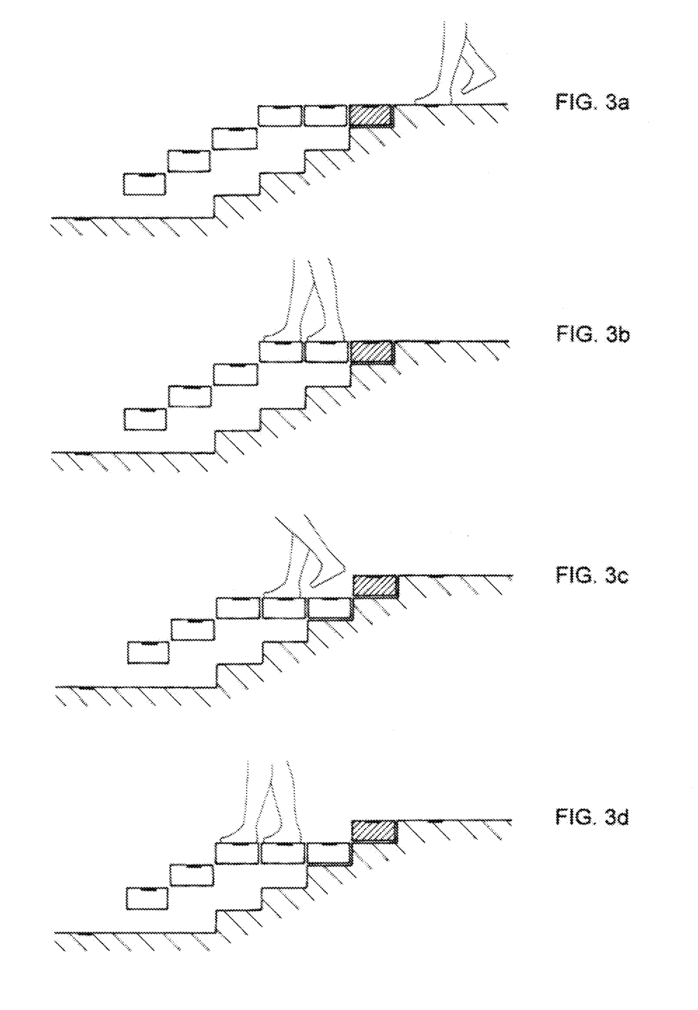

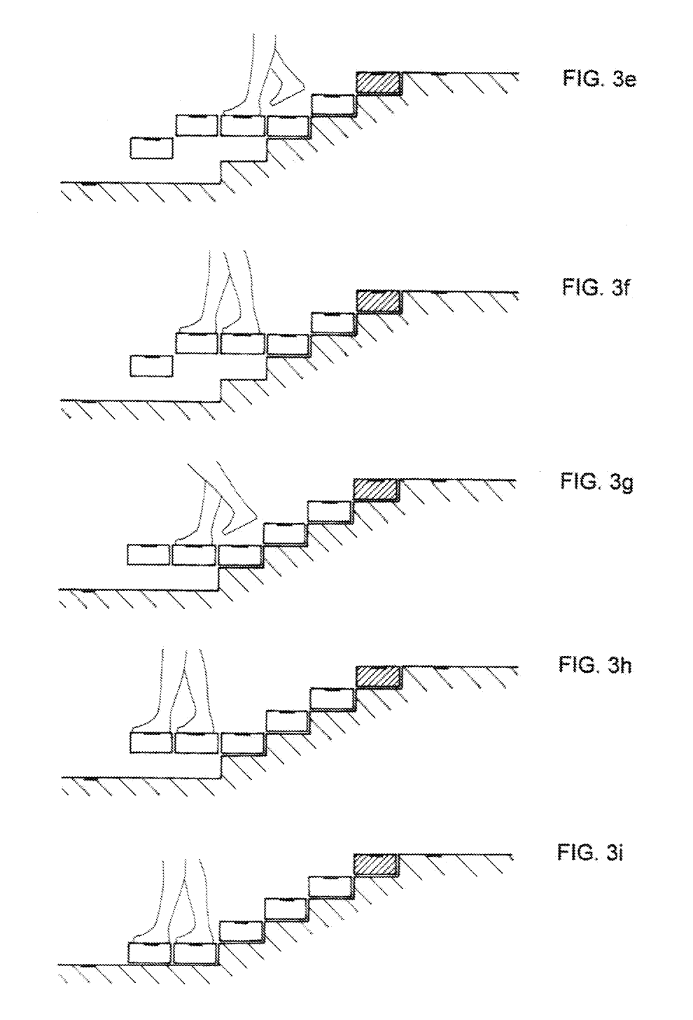

FIGS. 3a-i are schematic lateral views of the machine in FIG. 1 that illustrate the successive phases of the procedure in the downward direction.

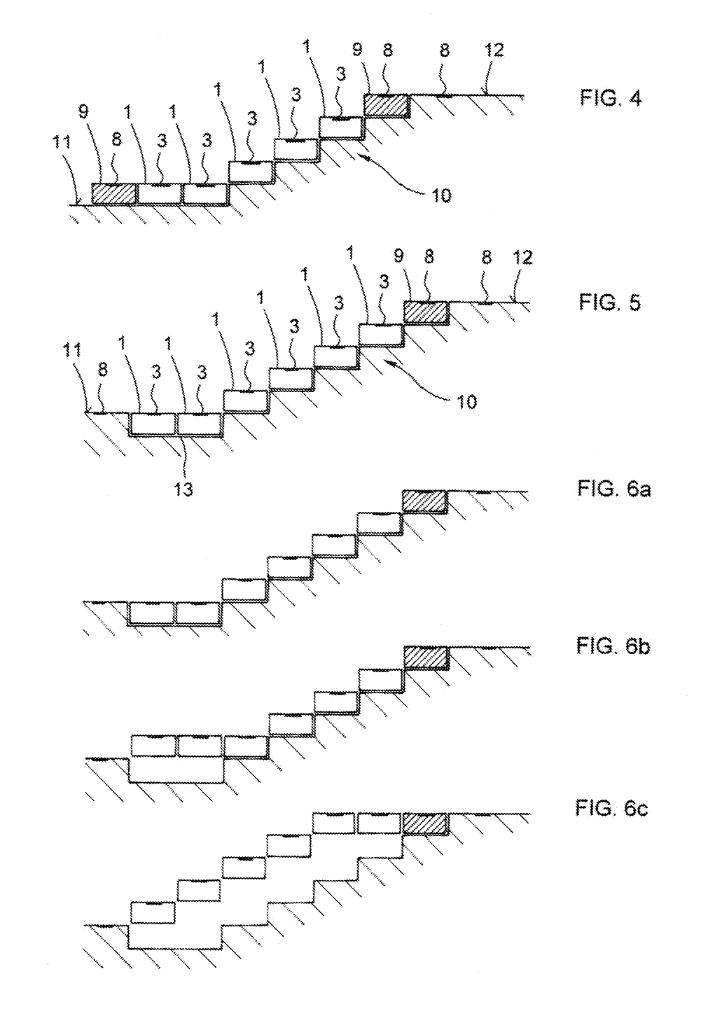

FIG. 4 is a schematic lateral view analogous to that shown FIG. 1, of a second form of implementation of the transporting machine.

FIG. 5 is a schematic lateral view analogous to that shown in FIG. 1, of a third form of implementation of the transporting machine.

FIGS. 6a-c are schematic lateral views of the machine in FIG. 5 that show some of the phases of the procedure in the upward direction.

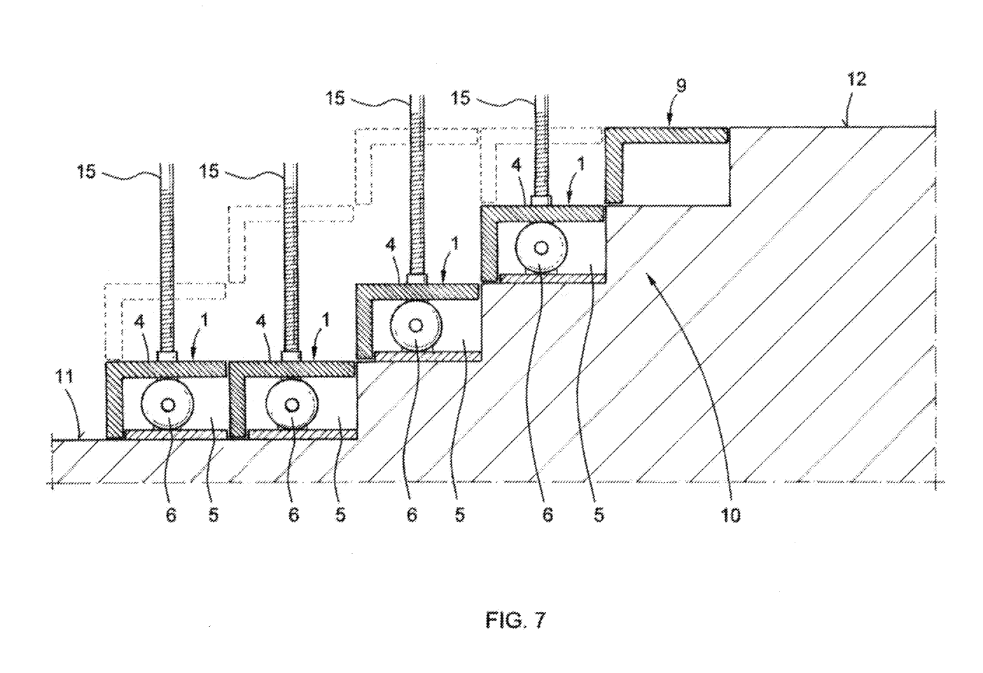

FIG. 7 is a schematic lateral view of the machine partially sectioned.

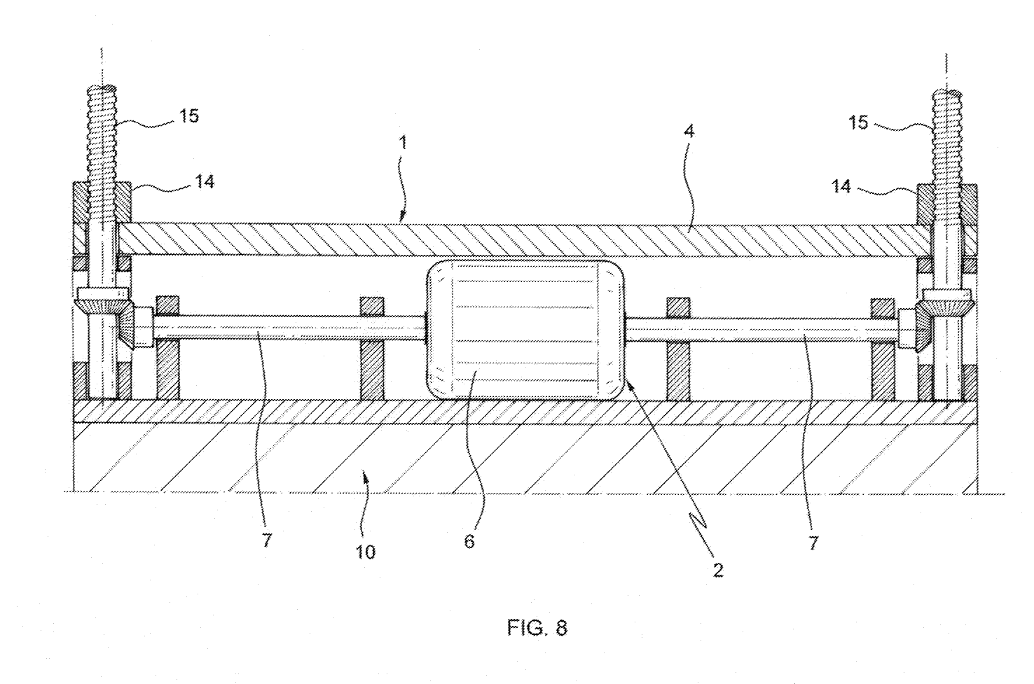

FIG. 8 is a schematic frontal view of a mobile step of the machine, partially sectioned.

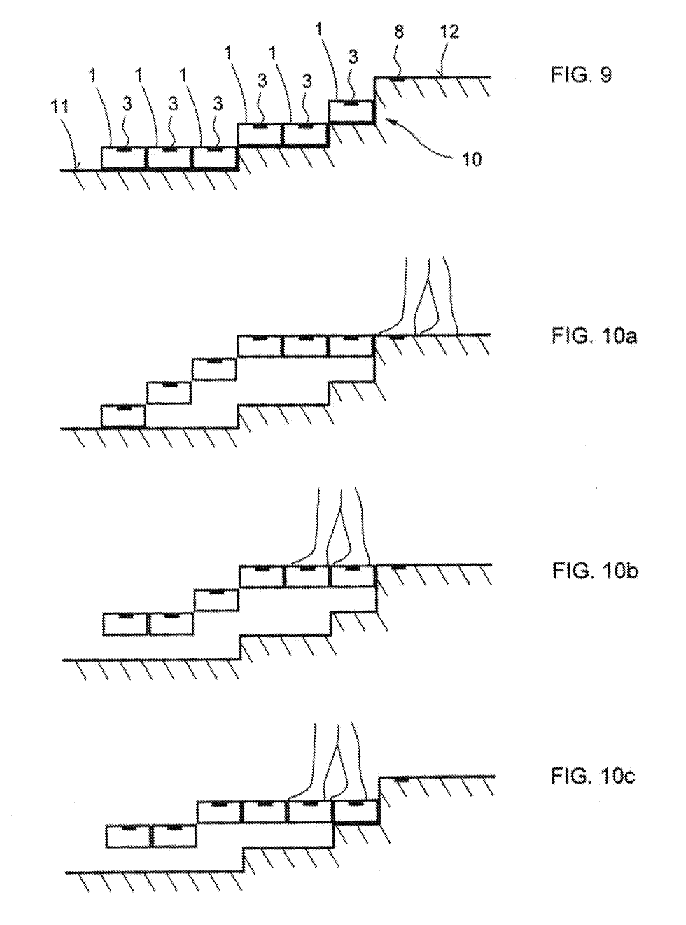

FIG. 9 is a schematic lateral view, analogous to that shown in FIG. 1, of a fourth form of implementation of the transporting machine.

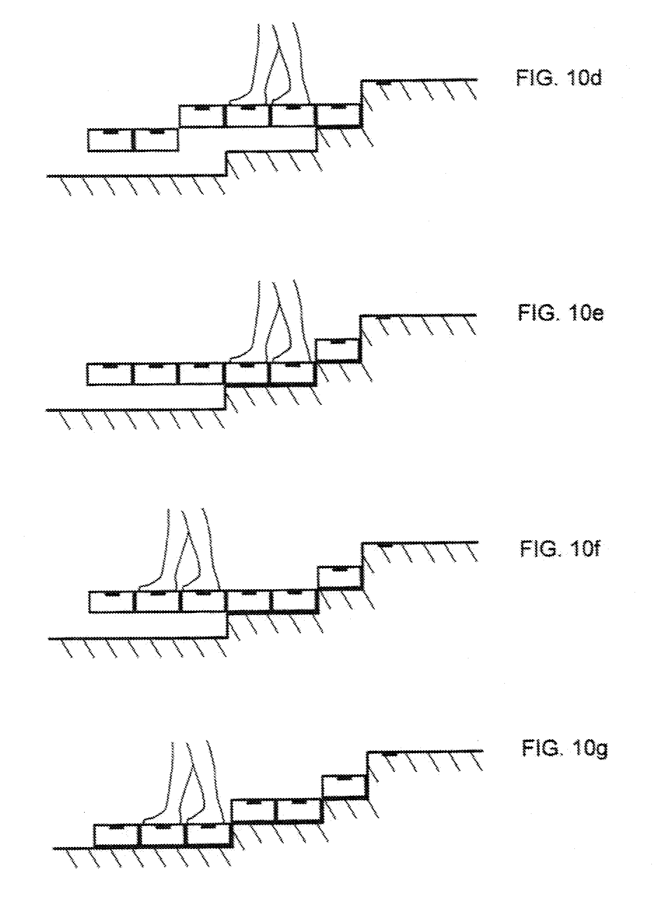

FIGS. 10a-g are schematic lateral views of the machine in FIG. 9 that illustrate the phases of the procedure in the downward direction.

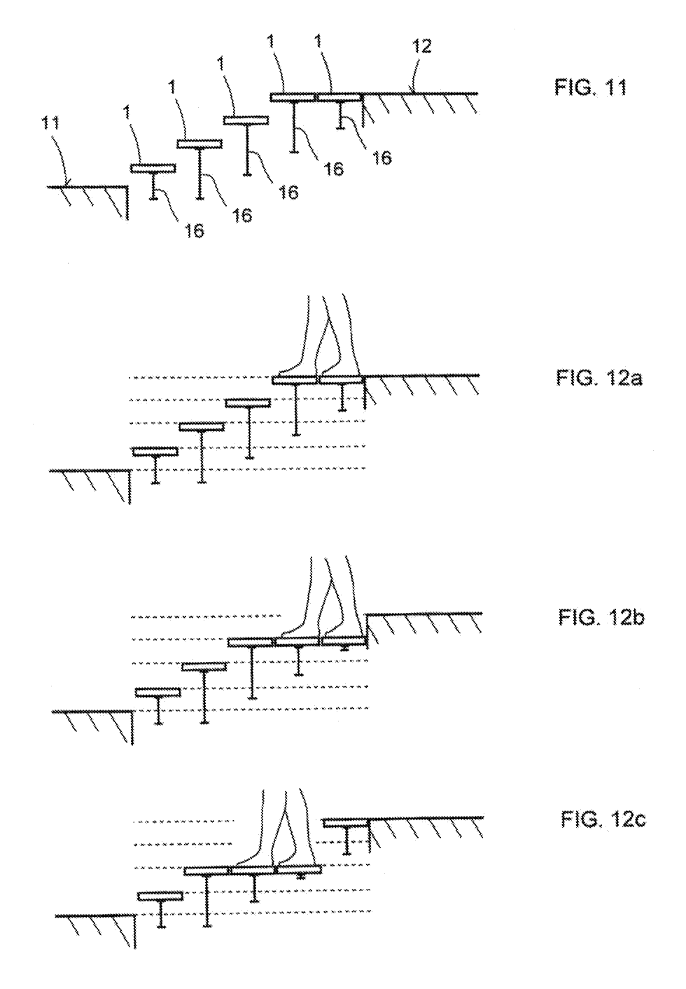

FIG. 11 is a schematic lateral view, analogous to that shown in FIG. 1, of a fifth form of implementation of the transporting machine.

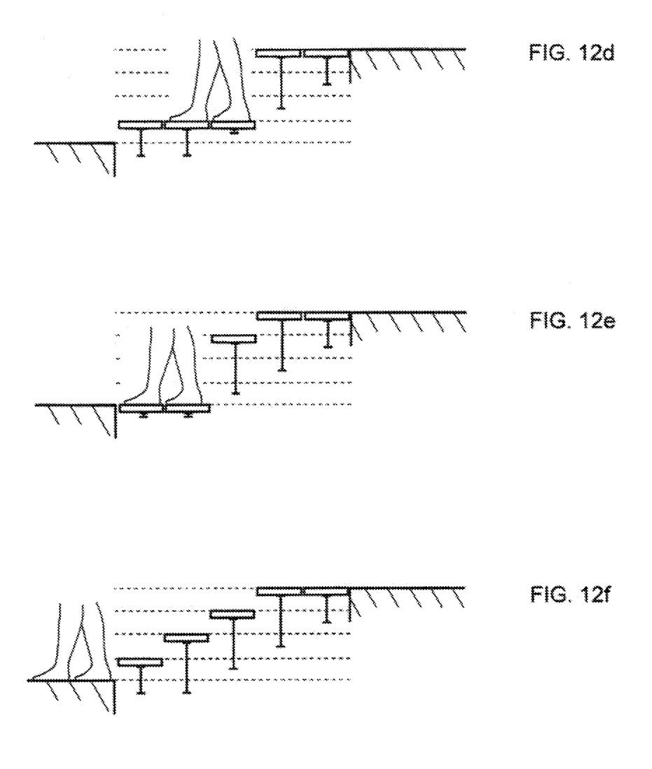

FIG. 12a-f are schematic lateral views of the machine in FIG. 11 that illustrate the phases of the procedure in the downward direction.

### DETAILED DESCRIPTION OF SPECIFIC FORMS OF IMPLEMENTATION OF THE INVENTION

FIG. 1 illustrates a first form of implementation of the machine according to the invention. The machine is installed over an existing fixed staircase (item 10), which in this example is formed by five steps and covers a slope between a low level (11) and a high level (12). Over this fixed staircase (10) are installed the mobile steps (1), in addition to a fixed step (9) as will be seen later on, in a way that by means of the installation of these steps (1,9) the fixed staircase (10) is transformed in the person-transporting machine according to the invention. The mobile steps (1) are displaced individually and only in the vertical direction, between a lowered position (FIG. 1) and one or two elevated positions (FIGS. 2b to 2h).

The following describes with more detail the disposition of such mobile steps (1) over the fixed staircase (10).

Over the lower level (11), next to the first step in the fixed staircase (10), are laid two contiguous mobile steps (1). The first of such mobile steps (1) is movable between a lowered position (FIG. 1) and a single elevated position (FIG. 2b-2h), while the second of such mobile steps (1) is movable between a lowered position (FIG. 1), a first elevated position (FIG. 2b-2c), and a second elevated position (FIG. 2d-2h).

Over each step of the fixed staircase (10), except the one situated just before the upper level (12), is placed a mobile step (1) movable between a lowered position (FIG. 1), a first elevated position (FIG. 2c-2g), and a second elevated position (FIG. 2h), with the exception that the last of these mobile steps (1), which is movable between one lowered position (FIG. 1) and an only elevated position (FIG. 2h).

A fixed step (9) that is not movable is placed over the step of the fixed staircase (10) that is previous to the upper position (12).

Each of the mobile steps (1) and fixed step (9) has a height corresponding to that of the step immediately superior of the fixed staircase (10). In this example all the steps of the fixed staircase (10), and thus all the steps (1) and (9), have the same height of 7 inches (17.78 cm). The range of vertical displacement of each mobile step 1 between each two successive positions is also of 7 inches (17.78 cm). Likewise, each of the mobile (1) and fixed (9) steps mounted over each step of the fixed staircase (10) has a depth corresponding to the underlying step. In this example all the steps of the fixed staircase (10) have the same depth of 12 inches (30.48 cm), and thus all the steps of type (1) and type (9) have the same depth of 12 inches (30.48 cm). The first two mobile steps 1 mounted over the lower level (11) have also a depth of 12 inches (30.48 cm). The width of steps of type (1) and type (9) is of 40 inches (101.60 cm). Of course, the invention can be implemented with steps of other dimensions. The dimensions indicated here are only one non-limiting example of implementation.

In summary, the dimensions of steps (1) and (9) are designed to correspond to these of the original steps in the fixed staircase (10) and form over this one, in the lowered position shown in FIG. 1, an equivalent staircase but raised.

In the upper face of each of the mobile steps (1) is placed a weight sensor (3) that constitutes a footstep detector. The assembly of these weight detectors (3) forms a detection system suitable to detect the footsteps of a person in the mobile steps (1). In other forms of implementation (not represented here), the detection system can be composed of other devices, such as photoelectric cells that detect the transit of a person over the mobile steps (1). Additionally, in the upper surface of the fixed step (9) and in the surfaces of the lower (11) and upper (12) levels of the fixed staircase (10) are placed other weight sensors (8) that also constitute footstep detectors.

FIGS. 7 and 8 show the structure of the mobile steps (1). Note that FIG. 7 does not correspond exactly to FIG. 1, since in FIG. 1 the fixed staircase (10) has only four steps. This is because FIG. 7 is a simplified version meant to illustrate the structure of the mobile steps. With the same simplifying end, in such FIG. 7 the weight detectors (3, 8) are not represented. In FIG. 7 mobile steps (1) are represented both in their lowered position (continuous line), and in their elevated position (dashed line).

As shown in FIG. 7 each mobile step (1) has an “L” shape profile such that in the lowered position of step (1) there is reserved, below the upper flat face (4) of the mobile step (1), a space (5) in which the main elements of the actuating mechanism (2) that act individually on such mobile step (1) are installed in order to realize its vertical displacement. Specifically, an electrical motor (6) is installed within space (5) for each mobile step (1).

As can be seen in FIG. 8 in this example of implementation the mentioned actuating mechanism (2) is formed by (i) the electric motor 6, (ii) a rotating horizontal shaft (7) powered by such electrical motor (6), (iii) two vertical threaded rods (15) situated on the two side ends of the mobile step (1) geared to this horizontal shaft (7) through a bevel gear whereby such vertical rods (15) have a thread in their superior end and are secured on their inferior end in bearings affixed to the fixed staircase (10), and (iv) blocks (14), solidly connected to the side ends of the mobile step (1), which have a vertical female thread each into which the vertical threaded rods (15) are screwed. In one of the vertical threaded rods (15) the thread has a right handed turn, while in the other vertical threaded rod (15) the thread has a left handed turn, such that when the horizontal shaft (7) turns in one direction the two vertical threaded rods (15) cause the vertical movement of step (1) in the same direction. Owing to the bevel gear between the horizontal shaft (7) and the vertical rods (15), and to the fact that the thread formed onto said rods is screwed into the blocks (14) solidly connected to the mobile step (1), the turn of the horizontal shaft (7) caused by the electric motor (6) is related in a bijective form with the vertical translation of the mobile step (1). This engineering solution offers an appropriate resistance to maintain the mobile step (1) in its elevated positions, under the weight of a person, while it enables the rapid and precise displacement of such mobile step (1) using the electrical motor (6). It also presents the advantage that it enables installing the machine over an existing fixed staircase without the need of making important alterations and without necessarily using all the width of the fixed staircase. With reference to the fixed step (9), it is formed by a profile in “L” as in the mobile steps (1), but it is devoid of displacement mechanism and affixed to the fixed staircase (10).

In some advantageous forms of implementation, the “L” shaped profiles that form the mobile steps (1) and the fixed step (9) are formed by a steel frame that supports a wooden plate that forms the tread of the step. This solution provides an appropriate resistance while significantly reducing the level of sound produced by the functioning of the electrical motors (6).

This machine has also a control system (not represented in the figures) that controls individually the extent of turning of each of the electrical motors (6) as a function of the footsteps detected by the sensors (3) that form the system of detection. In the example, the control system also takes into account the detection of a footstep provided by the sensors (8) situated in the low (11) and high (12) levels, which enables to know if a person enters or leaves the machine. This information is not essential but enables a safer functioning of the machine. The control system may be formed, as widely known, by an electronic module that performs the described controlling functions.

Next is described the procedure that is performed by this machine, first in the sequence of ascent by a person (FIGS. 2a to 2h) and later the sequence of descent (FIGS. 3a to 3i). The numeral references are taken from FIG. 1.

In the sequence of ascent (FIGS. 2a to 2h), a person enters the machine through the lower level (11). The corresponding footstep is detected first by the weight sensor (8) placed in the lower level (11), such that the control system knows that a person entered the machine. When the person places the two feet in the two first mobile steps (1) respectively (FIG. 2a), the weight sensors (3) situated in these detect it and then the control system orders the elevation of these two mobile steps (1), such that both become level with the third mobile step (1). The person continues walking over the horizontal platform formed by such three mobile steps (1) and places his two feet respectively over the second and third mobile steps (1) (FIG. 2c). Then the weight sensors (3) situated in these steps detect the weight and the control system orders the elevation of these two mobile steps (1), in such a way that the become level with the fourth mobile step 1 (FIG. 2d), forming these three mobile level steps an horizontal platform over which the person continues moving forward by walking. This sequence gets repeated (FIGS. 2e to 2h) until the person reaches the upper level (12) (FIG. 2h) and abandons the machine, the exit being detected by the weight sensors (8) situated in such upper level (12). As can be seen in the figures, at all times the person walks over a horizontal platform formed progressively at his transit by the leveling of the mobile steps (1).

In the sequence of descent (FIGS. 3a to 3i), a person can reach the machine through the upper level (12). The person's footstep is detected first by the first weight sensor (8) placed in the upper level (12), such that the control system knows that a person enters the machine through such upper level and orders the displacement of all the mobile steps (1) such that they get placed in the position shown in FIG. 3a, in which the two last mobile steps are level with the upper level (12) and the remainder mobile steps (1) form a stairway. The person continues advancing and his footstep is detected first by the following weight sensor (8) that informs the control system. When the person places the two feet respectively in the last two mobile steps (1) (FIG. 3b), the weight sensors (3) situated in these steps detect it and then the control system orders the descent of these two mobile steps (1) in such a way that both become level with the following mobile step (1) (FIG. 3c). This sequence of events is repeated (FIGS. 3d to 3i) until the person reaches the lower level (11) (FIG. 3i) and abandons the machine, the person's exit being detected by the weight sensor (8) situated in such lower elevation (11). Similar to the ascent sequence, in the descent sequence the person walks all the time over a horizontal platform formed progressively at his transit by the leveling of the mobile steps (1).

FIG. 4 shows an implementation variant similar to the previous one, with the exception that a fixed step (9), which does not move, is placed in the lower level (11) contiguous to the first mobile step (1). This avoids that in the descent sequence the person finds himself against an elevation such as that shown in FIG. 3g.

FIG. 5 shows another implementation variant in which the first two mobile steps (1) are placed in a depression (13) made on the fixed staircase (10), such that in the lowered position the two mobile steps (1) are level with the lower level (11). The operating principle is the same than the one shown previously for the first form of implementation.

FIGS. 6a, 6b and 6c show respectively the position for the mobile steps (1) in three different phases in the ascent sequence: the initial phase before the entry of a person through the lower level (11) (FIG. 6a), the following phase in which the two mobile steps (1) have been elevated after being stepped on (FIG. 6b), and the final phase of exit of the person through the upper level (12) (FIG. 6c).

FIGS. 9 and 10a-10g show another implementation variant that provides a specially increased level of safety in the sequence of descent. As can be seen in these figures, in this case the control system is configured such that when a person passes through the machine in the direction of descent, the two consecutive mobile steps (1) encountered by the person are always aligned in the same horizontal plane with the mobile step (1) that follows in the direction of descent. Due to this, the person has an increased feeling of safety since at all times the horizontal platform over which the person is walking is prolonged in front of his feet by the following mobile step (1). Specifically, the functioning is as follows. When the weight sensor (8) placed in the upper level (12) detects a person stepping in, the mobile steps (1) get placed in the position shown in FIG. 10a. As can be seen, there are three mobile steps (1) level in front of the person. When the weight detectors (3) of the first two of such three level mobile steps (1) detect two consecutive steps, such three mobile level steps (1) lower one position and remain aligned with the following mobile step (1), forming thus a temporary horizontal platform of four mobile level steps (1). This process gets repeated as the person advances walking through the machine. Note that the fixed staircase (10) shown in FIG. 9 has a particular configuration of its steps. This specific configuration enables to make the sequence previously described without the need that the mobile steps (1) get displaced more than two elevated positions. However, the expert in this matter will understand without difficulty that there are other forms of implementation of the invention that also perform this sequence over a conventional fixed staircase (10) such as the one shown in FIG. 1, if the mobile steps (1) are configured in such a way that they can adopt three elevated positions.

In all described forms of implementation, the control system displaces the mobile steps (1) at an adequate speed such that the person can advance walking over the horizontal platform formed progressively at his transit by the leveling of such mobile steps (1). Advantageously, the machine according to the invention can include means of regulation of the speed of displacement of the mobile steps (1). It can also include means of personal identification, such as for example a card reader, such that the control system only authorizes the use of the machine to authorized persons, and optionally, adjusts the velocity of displacement of the mobile steps to a pre-established value for each identified person.

While in the previous forms of implementation described the machine is mounted over a fixed staircase, in other forms of implementation the machine according to the invention can adopt the form of an independent ensemble devised to cover by itself a elevation with slope devoid of a fixed staircase.

FIGS. 11 and 12a-12f show another variant of implementation that only provides transportation in the descent sequence and that has the particularity that it does not require energy supply since the vertical descent of the mobile steps is caused by the own weight of the person over these. In this specific form of implementation, below each mobile step (1) are placed compressible media (16) able to undergo a reversible compression and configured in such a way that when a person gets over the mobile step (1) the weight of this person causes the descent of such mobile step (1) together with a reversible compression of the compressible media (16) with accumulation of energy. When the mobile step (1) is free of the person's weight the compressible medium (16) recovers its previous state and restores the accumulated energy thus causing the vertical elevation of the mobile step (1). Additionally there are anticipated means of retention (not represented) that are able to retain the mobile steps (1) in each of its vertical positions and that block or free the position of each mobile step (1) depending on whether there exists or not over such step the weight corresponding to that of one person. Thus, in this specific form of implementation, the detection system to detect the footstep or the transit of a person on the mobile steps (1) is constituted by such means of retention; the control system, that individually regulates the vertical displacement and the position of the mobile steps as a function of the footsteps or the passage detected by the detection system, is formed by the ensemble formed by such retention means and such compressible media (16); and the actuating mechanism, that acts over the mobile steps (1) to effect a displacement of these, is formed by such compressible media (16). The compressible media (16) can be formed, for example, by a system of hydraulic compression or preferably, by a system of springs. With respect to the means of retention, these can consist, for example, of a system of latches actuated by an elastic triggering device that acts over these to block or free one mobile step (1) depending on whether this and/or the adjacent mobile steps receive or not the weight of a person.

FIGS. 12a-12f show the different phases of the sequence of descent. To better illustrate the mechanism, the horizontal planes that correspond to the different positions of the mobile steps (1) have been represented by a dashed line. Initially, in the resting state of the machine, the mobile steps (1) are found in the position shown in FIGS. 11 and 12a. To simplify the explanation, the following refers to the five mobile steps (1) of the machine, numbered from the first to the fifth in the direction of descent. In FIG. 12a a person accesses the machine through the upper level (12) and places his two feet over the mobile steps first and second. The weight of the person on these two mobile steps causes that these are freed from the retention means and, under the weight of the person himself, against the pushing force of the compressible medium (16), descend until the position shown in FIG. 12b in which these two mobile steps are level with the third mobile step and in which they are blocked again by the retention media. The person then advances one step, such that he locates over the mobile steps second and third, which with his own weight causes the liberation of these two mobile steps from the retention means as well as the descent of these until the position shown in FIG. 12c. At the same time, as can be seen in FIG. 12c as well, the first mobile step, which is not under the weight of the person any more, is freed from the means of retention and returns to its initial position, moved by the pushing force of the compressible medium (16), where it becomes blocked again by the retention means. As can be seen in the following figures (FIGS. 12d-12f), this sequence is repeated at each level until the person reaches the lower level (11) and abandons the machine, remaining all the mobile steps again in the initial resting state.

The expert in the matter will understand that, in addition of the forms of implementation described, one can foresee multiple variants without deviating from the invention as it is defined in the independent claims. In particular, there are different constructive and mechanic solutions possible for the configuration of the mobile steps, as well as the configuration of the actuating mechanism that effects the vertical displacement of such steps.

1. Method to transport persons overcoming an elevation with slope that utilizes a mechanical machine provided of a plurality of mobile steps (1) contiguous covering the entire slope, characterized because such mobile steps (1) are at least three and such method includes the actions of:
Realizing a detection of the footstep or the transit of a person on such mobile steps (1);
As a function of this detection, realize a displacement of such mobile steps (1) individually and only in the vertical direction, controlling the displacement of the mobile steps (1) in such a way that at least two of these become level in the same horizontal plane in the area of transit of this person as this person moves forward stepping successively over the mobile steps (1).

2. Method according to claim 1, characterized because it includes the actions of:
Maintain level in a horizontal plane two of such contiguous mobile steps (1);
When the footstep of a person or the transit of a person is detected successively in these two contiguous mobile steps (1), make a vertical displacement of these two contiguous mobile steps (1) until they become level, in another plane, with a third of such contiguous mobile steps (1) that is contiguous and posterior to the two first ones in the direction of movement of such person, forming thus temporarily a horizontal platform constituted by these three contiguous level mobile steps (1);
Repeat the previous actions successively for the mobile steps (1) that follow in the direction of movement of this person.

3. Method according to claim 1, characterized because it includes the actions of:
Detecting in the upper level (12) of such slope the footstep of a person or the passage of a person that is going to go across the machine in the direction of descent;
Maintain level in a horizontal plane thee of such contiguous mobile steps (1);
When the footstep of a person or the transit of a person successively over the two first of such three contiguous level mobile steps (1) is detected, make a vertical displacement of such three contiguous level mobile steps (1) until they become level, in another horizontal plane, with a fourth of such mobile steps (1) that is contiguous and posterior to the three first ones in the direction of movement of such person, thus forming temporarily a horizontal platform formed by these four contiguous level mobile steps (1);
Repeat the previous actions successively for the mobile steps (1) that follow in the direction of movement of this person.

4. Method according to any of the claims 1 to 3, characterized because the vertical displacement of such mobile steps (1) is produced between a lowered position and one or several elevated positions, being the range of displacement between each two successive position equal or lower to 12 inches (30.48 cm), preferably ranging between 4 inches and 8 inches (between 10.16 cm and 20.32 cm).

5. Transporting machine of persons to overcome an elevation with slope, which comprises a plurality of mobile steps (1) placed covering a slope and a actuating mechanism (2) that acts on such mobile steps (1) to execute a displacement of these, characterized because there are at least three of such mobile steps (1) and they are individually movable only in the vertical direction, and because such transporting machine includes a detection system (3) to detect the footstep or the transit of a person over these mobile steps (1) and a control system to individually regulate the vertical displacement and the position of such mobile steps (1) as a function of the footsteps or transit detected by such detection system (3) over these mobile steps (1), such control system being configured to, as a function of the detection of footsteps realized by such system of detection (3), through such actuating mechanism (2), execute a displacement of such mobile steps (1) individually and only in the vertical direction, controlling such individual displacement of the mobile steps (1) in a manner that at least two of such mobile steps (1) get level in the same horizontal plane in the region of transit of this person as this person advances stepping successively the mobile steps (1).

6. Machine according to claim 5, characterized because such control system is configured to:
Maintain level in a horizontal plane two of such contiguous mobile steps (1);
When the footstep or the transit of a person is detected successively in these two contiguous mobile steps (1), execute a vertical displacement of these two contiguous mobile steps (1) until they become level, in another horizontal plane, with a third of such mobile steps (1) that is contiguous and posterior to the two first ones in the direction of movement of such person, thus forming temporarily a horizontal platform constituted by these three contiguous level mobile steps (1);
Repeat the previous actions successively for the mobile steps (1) that follow in the direction of movement of this person.

7. Machine according to claim 5, characterized because it includes a detection system (8) to detect the step or the transit of a person in the upper level (12) of such slope, and because such control system is configured to:
Detect the footstep or the transit of a person that is crossing the machine in the direction of descent in the upper level (12) of such slope;
When a footstep or the transit of a person is detected successively in the first two of such three contiguous level mobile steps (1), execute a vertical displacement o such three contiguous mobile steps (1) until they become level, in another horizontal plane, with a fourth of such mobile steps (1) that is contiguous and posterior to the three first ones in the direction of movement of such person, thus forming temporarily a horizontal platform constituted by these four contiguous level mobile steps (1);
Repeat the previous actions successively for the mobile steps (1) that follow in the direction of movement of this person.

8. Machine according to any of the claims 5 to 7 characterized because such mobile steps (1) are movable vertically between a lowered position and one or several elevated positions, being the range of displacement between each two successive positions inferior or equal to 12 inches (30.48 cm), preferably ranging between 4 inches and 8 inches (between 10.16 and 20.32 cm)

9. Machine according to any of the claims 5 to 8 characterized because such detection system (3) includes a footstep detector placed in each one of such mobile steps (1).

10. Machine according to claim 9, characterized because such step detector system is a sensor of weight placed in the upper face of each of these mobile steps (1).

11. Machine according to any of the claims 5 to 10 characterized because each of these mobile steps (1) has an upper flat surface (4) under which, in the lowered position of the mobile step (1), there is a space (5) reserved in which are placed the motor means (6) to activate the vertical displacement of such mobile step (1).
